(19) United States
(12) Patent Application Publication
(10) Pub. No.: US 2017/0300886 A1
(43) Pub. Date: Oct. 19, 2017

(54) CREDIT CARD-GAME CONTROLLER AND BANKNOTE BILL CHANGER

(71) Applicant: Wayne E. Snihur, Fort Lauderdale, FL (US)

(72) Inventor: Wayne E. Snihur, Fort Lauderdale, FL (US)

(21) Appl. No.: 15/490,486

(22) Filed: Apr. 18, 2017

Related U.S. Application Data
(60) Provisional application No. 62/323,906, filed on Apr. 18, 2016.

(51) Int. Cl. G06Q 20/18; G06Q 20/34; G06Q 20/38; G07F 7/04

(52) U.S. Cl. CPC G06Q 20/18; G07F 7/04; G06Q 20/34; G06Q 20/381

(57) ABSTRACT

An apparatus and method for transferring value from a credit card to a card acceptor in order to provide access to playing multiple game machines from a single payment source is described. A kiosk or vending machine performs two functions, including the activation of multiple games through the use of a single credit card. The apparatus includes a central unit for accepting the credit card activates remote game machines via hardwire or wirelessly. Additionally, the apparatus may provide change, in bill or coin form, using a bill acceptor that exchanges larger denominations for smaller.

### CROSS REFERENCE OF RELATED APPLICATIONS

This application claims the benefits of U.S. provisional application No. 62/323,906, filed Apr. 18, 2016 and entitled CREDIT CARD-GAME CONTROLLER AND BANKNOTE BILL CHANGER, which provisional application is incorporated by reference herein in its entirety.

### FIELD OF THE INVENTION

The present disclosure relates to an apparatus and method for accepting payment for game devices and exchanging forms of currency.

### BACKGROUND OF THE INVENTION

The present disclosure is generally directed to a method and apparatus for providing credit card accepting and validation devices coupled with a bill changer in an arcade or gaming establishment having numerous electronic gaming machines and a central unit for managing payments deposited.

Users of game machines in a gaming environment often play a variety of games on multiple machines. Game players often prefer to pay for their games using a credit card, as carrying cash and coins has become less common in the marketplace. For game users who wish to pay with a credit card, options are limited, because each game is generally not outfitted with a credit card accepting device due to cost and design constraints.

Currently, electronic gaming machines often have a bill validator for accepting and validating payments made with various currency denominations or tickets. Such integral bill validators and acceptors will determine whether a form of payment is valid and its denomination or value then communicate payment information to the host electronic gaming machine's processing unit for registration on the game credit meter. Simplification of payment in ways such as this for gaming consumers has increased business for gaming establishments significantly.

While some users may prefer to pay using a credit card, others may wish to use more traditional means of payment, such as bills and coins. For these customers, a coin changer and bill acceptor is necessary to convert large bills into smaller bills or bills into coins. Currently, arcade and game oriented businesses require multiple machines to service the various types of customers previously described above. Therefore, a need for a single machine that has the capability to accommodate customers who prefer to use credit cards as well as those who prefer to use cash is needed.

Therefore, an apparatus and method that enables a game provider to accommodate the various forms of payment customers may wish to use, while also increasing efficiency with regard to how those users distribute credits to each game, would be meeting a long felt need in the industry.

### SUMMARY

In the present disclosure, a central credit card acceptor and bill changer communicates with game machines. This apparatus and method allows a game user to insert a credit card into the machine, and have credits applied to the games connected from the credit card acceptor machine. The present apparatus and method allows a customer to their credit card as payment and choose multiple games to play without using cash for each round of play.

Credit card payment information is transmitted to a remote location wirelessly. The card is inserted into a card reader disposed at a gaming machine and the proper card identification and desired amount of funds to be borrowed on credit is entered via a keyboard. This information is then transmitted to a remote financial institution either directly or through an intermediate transaction processing facility. The method and apparatus of the present disclosure means a user is no longer required to make repeat trips to a bill changer during game play and, further, means a user no longer needs to carry cash to a game environment. Additionally, the machine provides the option of using the traditional method of exchanging bills for coins and using those coins to play games. The combination of these two features in a single machine creates a synergistic improvement in cost and efficiency for a game owner and significant improvement in the game playing experience for the game user.

### BRIEF DESCRIPTION OF THE DRAWINGS

Preferred embodiments of the present disclosure will now be described, by way of example only, with reference to the attached Figures, wherein:

FIG. 1 shows a schematic representation of the process for credit card payment and remote game selection.

FIG. 2 shows a schematic representation of the process for coin changing.

FIG. 3 shows a perspective view of the external features of the apparatus of the present disclosure.

FIG. 4 shows a front view of the internal components of the present disclosure.

FIG. 5 shows a perspective view of the components of the front panel of the device of the present disclosure.

FIG. 6 shows a schematic representation of the flex Input/Output (I/O) board of the present disclosure.

FIG. 7 shows a schematic representation of the universal board of the present disclosure.

### DETAILED DESCRIPTION

In the following description, the various embodiments of the present disclosure will be described in detail. However, such details are included to facilitate understanding of the disclosure and to describe exemplary embodiments for implementing the disclosure. Such details should not be used to limit the disclosure to the particular embodiments described because other variations and embodiments are possible while staying within the scope of the disclosure.

Furthermore, although numerous details are set forth in order to provide a thorough understanding of the present disclosure, it will be apparent to one skilled in the art that these specific details are not required in order to practice the present disclosure. In other instances details such as, well-known methods, types of data, protocols, procedures, components, networking equipment, processes, interfaces, electrical structures, circuits, etc. are not described in detail, or are shown in block diagram form, in order not to obscure the present disclosure. Furthermore, aspects of the disclosure will be described in particular embodiments but may be implemented in hardware, software, firmware, middleware, or a combination thereof.

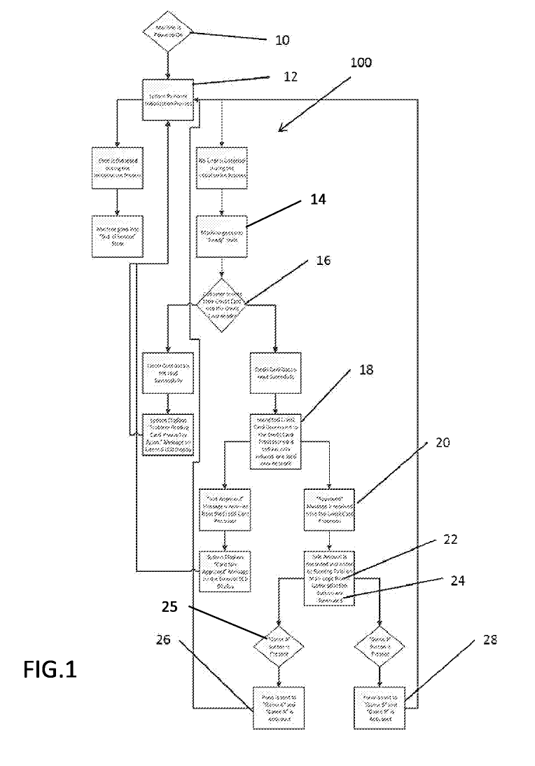

Referring now to FIG. 1, one process in an embodiment of a method 100 for a credit card acceptor and coin changer is shown. FIG. 1 shows the process for accepting a credit card and selecting remotes games. In the first step, the credit card acceptor and coin changing machine is powered on 10.

The machine is powered on 10 and initiates an installation process 12. If the machine is functioning properly it will be set to a ready state 14. A customer may then insert a credit card into the card reader 16. Once the credit card is read successfully the credit card data is encrypted and sent to a credit card processor 18 via cellular network or local area network (LAN).

An approved message 20 is then displayed to the customer from credit card processor 18. The sale amount is recorded and added to a running total on a main logic board 22. At this point, game selection buttons 24 are illuminated. One a game selection button is pressed 25 by a customer a pulse is sent to the corresponding game, such as game A 26 and game B 28 to permit the customer to play the game. Communication between the credit card acceptor and bill changer device and each respective game machine may be wired or wireless.

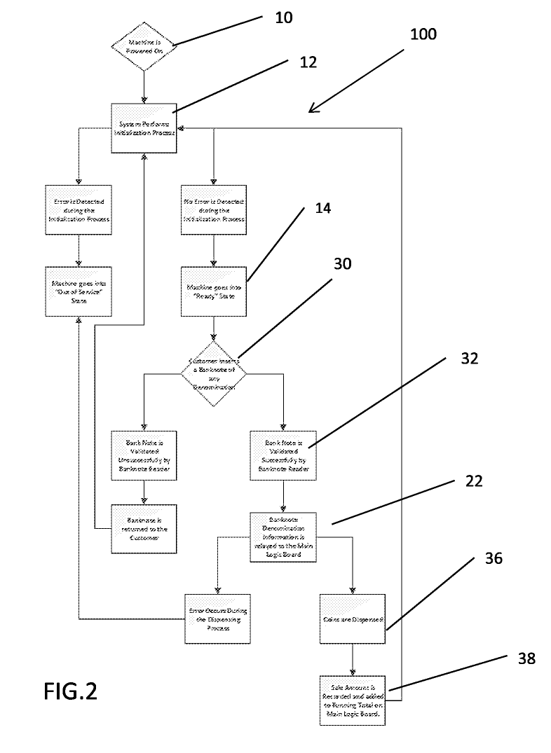

Referring now to FIG. 2, an additional process in an embodiment of a method 100 for a credit card acceptor and coin changer is shown. The schematic diagram illustrates one process in one embodiment of the present method 100. FIG. 12 shows the process for the machine to accept a banknote, whereupon the customer receives coins in exchange for the banknote. In one embodiment, a customer may receive smaller denominations of bills instead of coins.

Once the machine is powered on 10, it initiates an installation process 12. If the machine 10 is functioning properly it will be set to a ready state 14. A customer may then insert a banknote into the banknote acceptor 30. The banknote is then validated by a banknote reader 32. The banknote denomination information is relayed from the banknote reader 32 to the main logic board 22. Coins are then dispensed by the coin dispenser 36. The sale amount is recorded and added to a running total 38 on the main logic board 22.

The credit card accepting and coin changing method 100 depicted by FIGS. 1 and 2 shows the principle steps to process payments made to a credit card accepting and coin changing device which is operatively close enough to the electronic game machines currently to be used by a player thus enabling the player to make payment to add credits to his game, or change bills, without leaving the proximity of the games being played.

When the credits registered on the player's game displayed an the electronic game machine have been depleted, a user would be able to insert currency into the bill validator 210 associated with the game machine 26 which then dispenses coins, or insert a credit card into credit card reader 204. When the means of payment are in the form of currency, this validation comprises a determination of the monetary value and that it is not a counterfeit document. For other non-currency means of payment, this validation may comprise determining the monetary value and some form of validating identification information.

If the credit card acceptor and bill changer accepts the payment from a credit card, then, based on information in the payment acceptance message, either credits the player's account on the credit card acceptor and bill changer and transfers credits to a specific game machine after pressing a game machine button associated with that game machine 26.

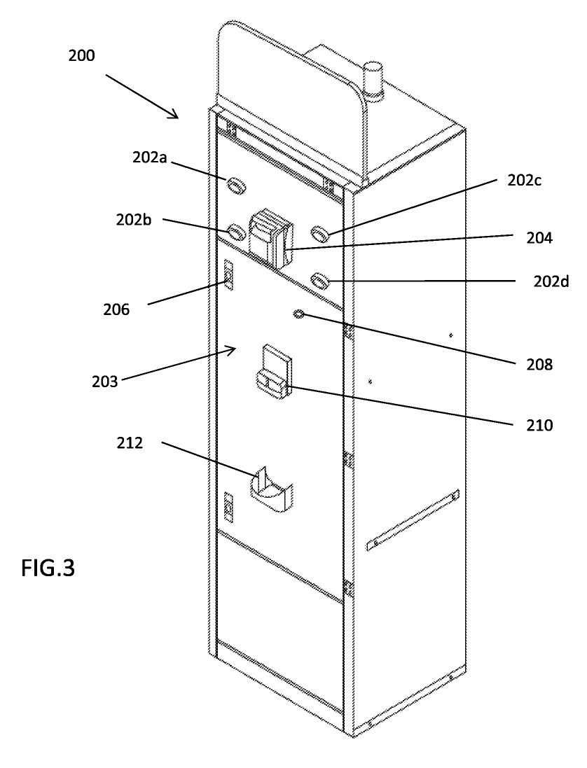

FIGS. 3-5 show the external features and internal components of the device of the present disclosure.

FIG. 3 shows a credit card acceptor and bill changer 200. The credit card acceptor and bill changer 200 includes a plurality of game activation buttons such as 202a and 202b that can be located on at the front of a front panel 203. Also shown in credit card reader 204. The credit card reader 204 accepts credit cards for creating an account through which games can be selected. Once credit card reader 204 has read a credit card and funds have been applied to the user, the user can select which games to apply the credits to by pressing game activation buttons 202. T-Handles 206 are shown in FIG. 1. An out of service light 208 is shown to indicate a need for servicing. Bill validator 210 accepts bills which can be changed into smaller denominations or coins where the user prefers this type of payment over credit card use. Once a bill has been fed into bill validator 210 and accepted, coins may be dispensed into coin cup 212.

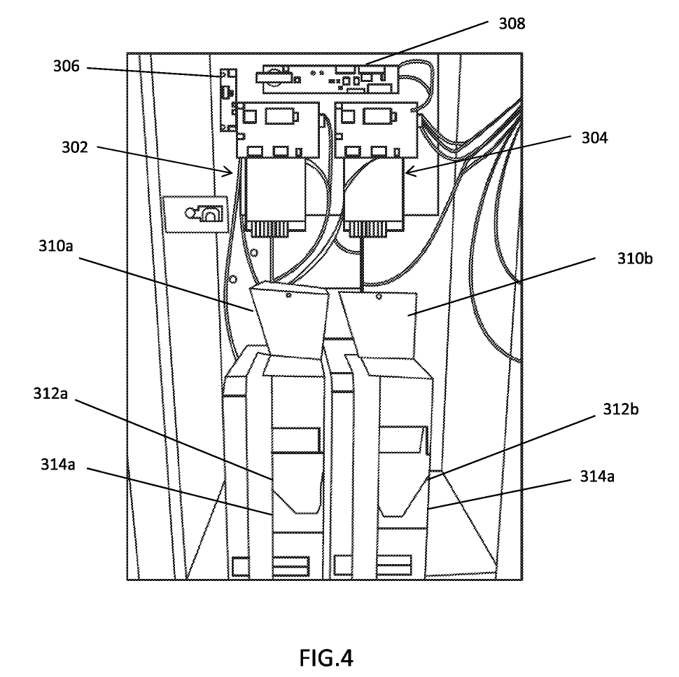

FIG. 4 shows a front view of the inside of credit card acceptor and bill changer 200. A universal board for game activation 302 is shown. A universal board for bill changing 304 is shown. A game interface board 306 is shown. An I/O board 308 is shown. Hopper extensions 310a and 310b are shown. Hopper chutes 312a and 312b are shown. Hoppers 314a and 314b are shown. It should be understood that the various specific communication connections, boards, switches, and routers which may be required to achieve the network communication functions for the credit card acceptor and bill changer may not be shown but are commonly known in the art. While a credit card reader 210 is preferred, it should be obvious that any payment accepting device falls within the scope intended herein. Such payment acceptance devices could accept other forms of payment or even wireless mobile devices with the ability to communicate valid payment information to the payment accepting device through any wireless cell or internet means known in the art.

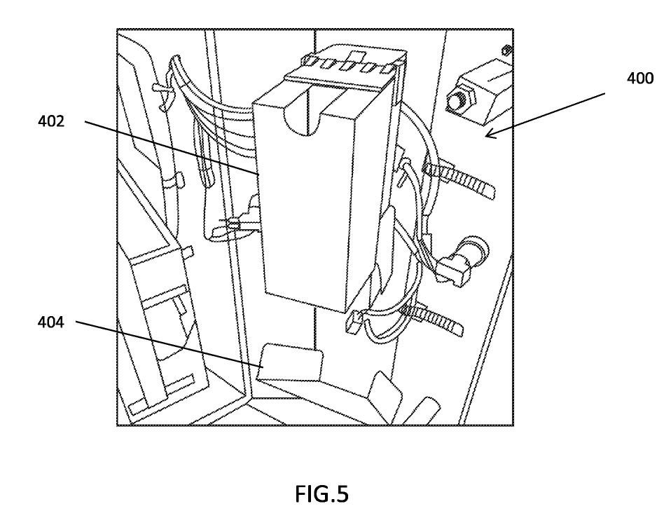

FIG. 5 shows a perspective view of the inside of the front panel 400. A bill acceptor/validator with bill stacker 402 is shown. Coin dispenser 404 associates with components for hopper 314 to allow coins to be transferred to coin cup 212 upon validation of a bill by bill validator 210.

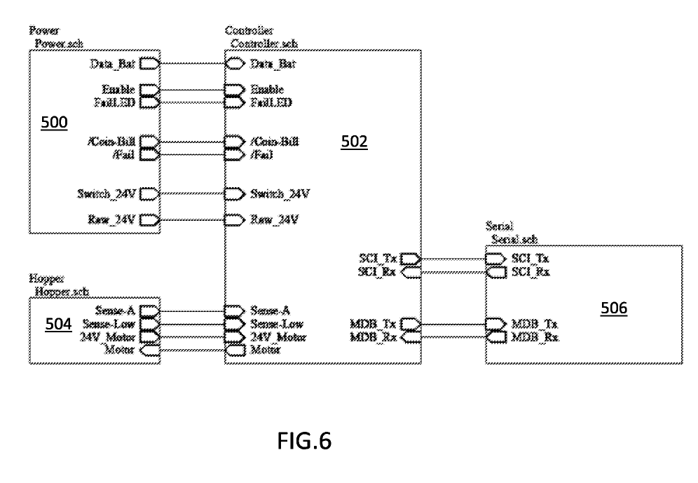

FIG. 6 shows a schematic representation of a configuration of components for the flex I/O board 510 of the present disclosure. Power source 500 is in communication with controller 502. Controller 502 is in communication with hopper 504 and serial 506.

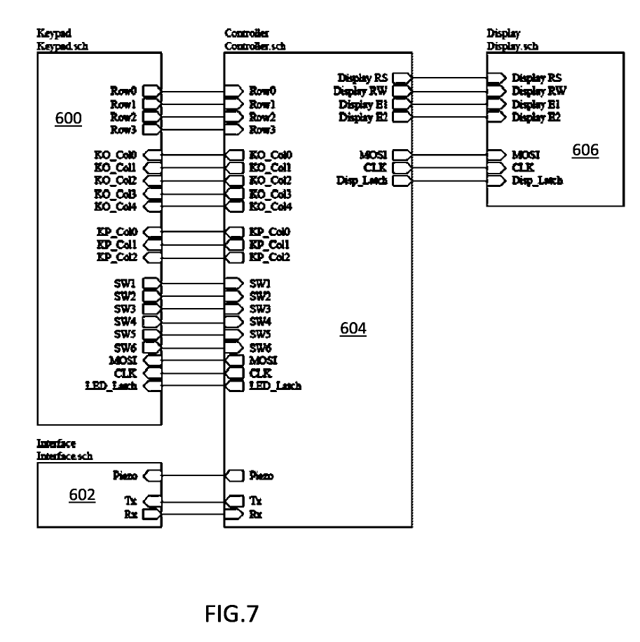

FIG. 7 shows a schematic representation of a universal board of the present disclosure. Keypad 600 is in communication with controller 604. Controller 604 is in communication with interface 602 and display 606.

Although the disclosure has been described with reference to certain preferred embodiments, it will be appreciated by those skilled in the art that modifications and variations may be made without departing from the spirit and scope of the disclosure. It should be understood that applicant does not intend to be limited to the particular details described above and illustrated in the accompanying drawings.

What is claimed is:

1. A method for paying for gaming machines in a gaming environment comprising the steps of:
providing a payment machine having a credit card reader and a bill acceptor;
providing at least one electronic gaming machine wherein each of the at least one electronic gaming machine is communicatively connected to the payment machine;
accepting a means of payment in a form of at least one of a credit card and a bill at the payment machine;
remotely transmitting credit card payment information to a credit card processor when a credit card is inserted into the payment machine;
identification of a designated electronic gaming machine to which a credit is requested when the credit card is used for payment;
said payment machine communicating a credit to said electronic game machine designated by said payment machine; and
said payment machine dispensing an appropriate amount of lesser denominations when the bill is accepted in the payment machine.

2. The method of claim 1, wherein the credit card reader and a bill acceptor are integrated on a front panel.

3. The method of claim 1, wherein the credit card reader communicates with a plurality of game activation buttons on a front panel of the payment machine.

4. The method of claim 2, wherein the plurality of game activations illuminate when a credit card is validated by the credit card reader.

5. The method of claim 1 wherein said payment machine receives asset identification information.

6. The method of claim 1 wherein encrypted credit card data is sent to the credit card processor.

7. The method of claim 1, wherein a sale amount is recorded and added to a total on a main logic board.

8. The method claim 1, wherein game selection buttons are illuminated.

9. The method of claim 1 wherein a payment acceptance message includes at least one key for selecting an electronic game machine wherein each key corresponds to an individual game machine.

10. The method of claim 1, further comprising designating that said at least one corresponding electronic game machine transmit a credit return message to the payment machine which initiates the transfer of remaining game credit value back to a designated player account.

11. The method of claim 1, further comprising a memory means for storing information regarding user accounts and asset identification.

12. The method of claim 1 where the plurality of payment accepting devices include bill validators.

13. The method of claim 1 where the payment machine includes devices equipped to accept at least one of bills, tickets, and credit card payments.

14. An apparatus for game play and coin changing comprising:
a machine having a credit card reader for accepting a credit card;
at least one game selection key for communicating an amount of credits to a corresponding game machine;
a bill acceptor for changing banknote bills into lesser denominations.

15. The apparatus of claim 14, further comprising a means for remotely transmitting credit card payment information to a credit card processor.

16. The apparatus of claim 14, wherein the bill acceptor is physically linked to the credit card reader.

17. The apparatus of claim 14, wherein a front panel contains the credit card reader and the bill acceptor.

18. The apparatus of claim 14, wherein each of the at least one electronic gaming machine is communicatively connected to the payment machine.

19. The apparatus of claim 14, further comprising an electronic link between the credit card reader and the bill acceptor.

20. A method for paying for gaming machines in a gaming environment comprising the steps of:
providing a payment machine having a credit card reader and a bill acceptor;
providing at least one electronic gaming machine wherein the at least one electronic gaming machine is communicatively connected to the payment machine;
accepting a means of payment in a form of at least one of a credit card or bill at the payment machine;
remotely transmitting credit card payment information to a credit card processor when a credit card is inserted into the payment machine;
identification of a designated electronic gaming machine to which a credit is requested when a credit card is used for payment;
said payment machine communicating a credit to said at least one electronic game machine designated by said payment machine; and
said payment machine dispensing an appropriate amount of lesser denominations when a bill is accepted in the payment machine.
